(19) United States
(12) Patent Application Publication
(10) Pub. No.: US 2013/0022858 A1
(43) Pub. Date: Jan. 24, 2013

(54) LITHIUM BATTERY SEPARATOR WITH SHUTDOWN FUNCTION

(71) Applicants: Stephen Mazur, Wilmington, DE (US); Simon Frisk, Newark, DE (US); Natalia V. Levit, Glen Allen, VA (US)

(72) Inventors: Stephen Mazur, Wilmington, DE (US); Simon Frisk, Newark, DE (US); Natalia V. Levit, Glen Allen, VA (US)

(73) Assignee: E.I. DU PONT DE NEMOURS AND COMPANY, Wilmington, DE (US)

(21) Appl. No.: 13/353,468

(22) Filed: Jan. 19, 2012

Related U.S. Application Data
(60) Provisional application No. 61/568,680, filed on Dec. 9, 2011.
(60) Provisional application No. 61/434,029, filed on Jan. 19, 2011.

(51) Int. Cl. H01M 2/14; B05D 1/16; B32B 5/26; B32B 5/02; H01M 2/16

(52) U.S. Cl. 429/145; 442/59; 442/74; 442/393; 427/58

(57) ABSTRACT

This invention relates to separators for batteries and other electrochemical cells, especially lithium-ion batteries, having a shutdown mechanism. The separator is a laminate that contains a nonwoven nanoweb and a porous layer composed of a plurality of thermoplastic particles having particle size smaller than the mean flow pore size of the nanoweb. The shutdown layer melts and starts to flow at a desired temperature, and restricts the ion flow path, resulting in a substantial decrease in ionic conductivity of the separator at the desired shutdown temperature, while leaving the separator intact.

### CROSS REFERENCE TO RELATED APPLICATIONS

This application claims benefit under 35 U.S.C. §119(e) of U.S. application No. 61/434,029 filed Jan. 19, 2011, and U.S. application No. 61/568,680 filed Dec. 9, 2011, the entire disclosures of both are hereby incorporated by reference.

### TECHNICAL FIELD

The subject matter hereof is related to the field of separators for electrochemical cells, and their use in batteries, especially in lithium ion batteries.

### BACKGROUND

Separators for Li-ion batteries and other electrochemical cells are often required to maintain structural integrity (dimensional stability, low shrinkage) at high temperatures, and also offer shutdown behavior. The polyolefin based microporous separators in present use, which are made from polyethylene or polypropylene, offer shutdown properties but are disadvantageously limited in high temperature stability. At high temperatures, softening and melting of the polymer can lead to shutdown behavior, and high shrinkage can lead to poor dimensional stability of the separator. The functionality of shutdown is therefore significantly diminished by high shrinkage and lower dimensional stability.

Separators without shutdown function are also known and are required in some applications by the manufacturers of batteries. For example, high temperature nonwoven nanofiber separators made of polyimide offer exceptional high temperature stability and melt integrity, but do not provide safety shutdown behavior. A recent attempt to provide such a high temperature stable battery separator having a shutdown mechanism is disclosed in U.S. Pat. No. 7,691,528. The separator comprises a porous carrier consisting mainly of a woven or non-woven glass or polymeric fabric having a layer of inorganic particles coated thereon and also a layer of shutdown particles bonded to the inorganic layer. One drawback of this approach, however, is the difficulty of making a thin separator with uniform pore size distribution within the highly non-uniform pore structures of the common fiber size nonwovens. Another disadvantage is related to the imperfect binding capacity of the inorganic particles to each other and to the nonwoven carrier, which results in inorganic particles being dislodged during separator handling and battery manufacturing.

A need thus remains for Li and Li-ion batteries prepared from materials that meet the dimensional stability requirements and an ability to shutdown in the event of a rise in internal temperature (such as during a short circuit) while maintaining a sound structural integrity at elevated temperatures.

### SUMMARY OF THE INVENTION

The subject matter hereof is directed to a separator for electrochemical cells, especially lithium ion batteries, comprising nanofibers arranged into a nonwoven web. The separator further comprises a coating composed of a plurality of thermoplastic particles. The coating flows at a desired temperature and restricts the ion flow path in the cell, resulting in a decrease in ionic conductivity of at least 50% (i.e. resulting in an increase in ionic resistance by at least 2 times) in comparison with the ionic conductivity of the separator at room temperature.

The separator is a laminate comprising a first layer comprising nanofibers arranged into a nonwoven web, and second layer comprising a first set of thermoplastic particles, said second layer being bonded to the first layer and covering at least a portion of the first layer.

One skilled in the art will understand that not all of the surface of the nanoweb needs to be coated as long as at least a portion of the nanoweb is coated with particles, and upon reaching a threshold temperature, shutdown function can be achieved with the coating of particles. In some embodiments, the nanofibers may be polymeric. The nonwoven web can have a mean flow pore size of between 0.1 microns and 5 microns, and the particles can be aggregated, can be bonded into a coherent layer, and/or can have a number average particle size less than or equal to the mean flow pore size. The thickness of the separator can be less than 100 μm, or less than 50 μm, or less than 25 μm, or less than 15 μm.

The particle size distribution of the particles in the second layer can be normal, log-normal, symmetric or asymmetric about the mean or can be characterized by any other type of distribution. Preferably the majority of the particles have a size less than the mean flow pore size of the nanoweb. In a further embodiment of the invention, greater than 60%, or even greater than 80% or 90%, of the particles have a size less than the mean flow pore size of the nanoweb.

The particles can be spherical, elongated, non-spherical or any other shape. The particles are preferably made of polymer, and can be made of homopolymer or copolymer thermoplastic olefins or other thermoplastic polymers. The polymer composing the particles can branched, oxidized, or functionalized. The particles can further be produced by micronization, grinding, milling, prilling, electrospraying or direct polymerization. The particles are preferably colloidal particles that have been flocculated into a coherent material before being applied to the nanoweb layer. The set of particles can therefore be composed of a blend of particles having different compositions, sizes, shapes and functionalities.

In a further embodiment, the separator comprises a third layer of a second set of particles coated onto a surface of the first or second layers. The third layer can be located adjacent to either or both of the first two layers. The number average particle size of the second set of particles can be equal to the mean flow pore size of the nonwoven web, or it can be less than the mean flow pore size of the web, or greater than the mean flow pore size or combinations thereof. The maximum number average particle size of the second set of particles is such that the target thickness of the coated nanoweb is not exceeded.

Additional layers comprising particles can be subsequently coated to the coated nonwoven web forming a multilayered coating.

In a further embodiment, the separator comprises polymeric nanofibers arranged onto a plurality of distinct nonwoven webs where the nonwoven webs are separated from each other by one or more layers of thermoplastic particles situated between the webs and bonded to their surfaces. The plurality of webs may be two webs.

In a still further embodiment, the separator offers a shutdown functionality , such that the ionic resistance of the separator increases by at least 2 times the initial resistance upon reaching a threshold temperature, and is structurally and dimensionally stable, as defined by a shrinkage of less than 10%, 5%, 2% or even 1% at temperatures up to 200° C. to prevent electrical short circuiting due to the degradation or shrinkage of the separator.

The subject matter hereof further provides an electrochemical cell, especially lithium-ion batteries, which comprise a separator as described herein, and a method of making such separators and electrochemical cells containing such separators.

The subject matter hereof is also directed to a process for manufacturing a separator. The process comprises the step of coating a nanoweb with a floc of thermoplastic particles wherein the floc comprises multiple particles that have a number average particle size of less than or equal to the mean flow pore size of the nanowebs and the floc average size is greater than the mean flow pore size of the web.

### BRIEF DESCRIPTION OF THE DRAWINGS

FIG. 1 shows a schematic representation of a cell used for measuring the shutdown function of separators.

FIG. 2 shows the effect of temperature on electrical resistance for a comparative example.

FIG. 3 shows the effect of temperature on electrical resistance for one embodiment of the invention.

### DETAILED DESCRIPTION OF THE INVENTION

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

### Definitions

Terms as used herein are defined as follows:

The term “nonwoven” means here a web including a multitude of essentially randomly oriented fibers where no overall repeating structure can be discerned in the arrangement of fibers. The fibers can be bonded to each other, or can be unbonded and entangled to impart strength and integrity to the web. The fibers can be staple fibers or continuous fibers, and can comprise a single material or a multitude of materials, either as a combination of different fibers or as a combination of similar fibers each comprising of different materials. The fibers, including nanofibers, can be constructed of organic or inorganic materials or a blend thereof. The organic material of which the fiber is made can be a polymeric material.

The term “nanoweb” as applied to the present invention is synonymous with “nano-fiber web” or “nanofiber web” and refers to a nonwoven web constructed predominantly of nanofibers. “Predominantly” means that greater than 50% of the fibers in the web are nanofibers, where the term “nanofibers” as used herein refers to fibers having a number average diameter less than 1000 nm, even less than 800 nm, even between about 50 nm and 500 nm, and even between about 100 nm and 400 nm. In the case of non-round cross-sectional nanofibers, the term “diameter” as used herein refers to the greatest cross-sectional dimension. The nanoweb of the invention can also have greater than 70%, or 90% or it can even contain 100% of nanofibers.

In some embodiments of the invention, the nanofibers employed herein can be prepared from one or more fully aromatic polyimides. For example, the nanofibers employed in this invention may be prepared from more than 80 wt % of one or more fully aromatic polyimides, more than 90 wt % of one or more fully aromatic polyimides, more than 95 wt % of one or more fully aromatic polyimides, more than 99 wt % of one or more fully aromatic polyimides, more than 99.9 wt % of one or more fully aromatic polyimides, or 100 wt % of one or more fully aromatic polyimides.

In one embodiment, an article as provide herein can be a separator that exhibits a shutdown property. The separator is a laminate comprising a first layer comprising polymeric nanofibers arranged into a nonwoven web, and second layer comprising a first set of aggregated thermoplastic particles. The second layer can be bonded to the first layer in a face to face relationship. The nonwoven web has a mean flow pore size of between 0.1 microns and 5 microns, and the particles are bonded into a coherent layer and have a number average particle size less than or equal to the mean flow pore size. By “coherent layer” means that the bonded particles form a continuous porous layer over at least a fraction of the surface of the nanofiber nonwoven web. “Continuous” means that the particles may be fused, or discrete and in contact with each other.

The subject matter hereof further provides an electrochemical cell, especially a lithium ion battery, that comprises an article hereof, namely the polyimide nanoweb separator that exhibits a shutdown property as a separator between a first electrode material and a second electrode material. Electrochemical cells mentioned herein may be lithium primary batteries, lithium ion batteries, capacitors, etc. Lithium and lithium ion batteries are especially preferred in the present invention.

Nanowebs suitable for use in the invention may be fabricated, for example and without limitation, by a process selected from the group consisting of electroblowing, electrospinning, and melt blowing. Electroblowing of polymer solutions to form a nanoweb is described in detail by Kim et al. in WO 03/080905, corresponding to U.S. patent application Ser. No. 10/477,882, incorporated herein by reference in its entirety. The electroblowing process in summary comprises the steps of feeding a polymer solution, which is dissolved into a given solvent, to a first spinning nozzle; discharging the polymer solution via the spinning nozzle, into an electric field, while injecting compressed air through a separate second nozzle adjacent to the spinning nozzle such that the compressed air impinges on the polymer solution as it is discharged from the lower end of the spinning nozzle; and spinning the polymer solution on a grounded suction collector under the spinning nozzle.

A high voltage may be applied to either the first spinning nozzle or the collector in order to generate the electric field. A voltage may also be applied to external electrodes not situated on the nozzle or the collector in order to generate a field. The voltage applied may range from about 1 to 300 kV and the polymer solution may be compressively discharged through the spinning nozzle under a discharge pressure in the range of about 0.01 to 200 kg/cm².

The compressed air can have a flow rate of about 10 to 10,000 m/min and a temperature of from about room temperature to 300° C.

Polyimide nanowebs suitable for use in this invention may be prepared by imidization of a polyamic acid nanoweb where the polyamic acid is a condensation polymer prepared by reaction of one or more aromatic dianhydride and one or more aromatic diamine. Suitable aromatic dianhydrides include but are not limited to pyromellitic dianhydride (PMDA), biphenyltetracarboxylic dianhydride (BPDA), and mixtures thereof. Suitable diamines include but are not limited to oxydianiline (ODA), 1,3-bis(4-aminophenoxy)benzene (RODA), and mixtures thereof. Preferred dianhydrides include pyromellitic dianhydride, biphenyltetracarboxylic dianhydride, and mixtures thereof. Preferred diamines include oxydianiline, 1,3-bis(4-aminophenoxy)benzene and mixtures thereof. Most preferred are PMDA.and ODA.

In the polyamic acid nanoweb imidization process hereof, the polyamic acid is first prepared in solution; typical solvents are dimethylacetamide (DMAc) or dimethyformamide (DMF). In one method suitable for the practice of the invention, the solution of polyamic acid is formed into a nanoweb by electroblowing, as described in detail by Kim et al. in WO 03/080905.

Imidization of the polyamic acid nanoweb so formed may conveniently be performed by any process known to one skilled in the art, such as by the process disclosed in U.S. patent application Ser. Nos. 12/899,770 or in 12/899,801 (both filed Oct. 7, 2010), the disclosures of which are incorporated by reference herein in their entireties. For example, in one process imidization may be achieved by first subjecting the nanoweb to solvent extraction at a temperature of approximately 100° C. in a vacuum oven with a nitrogen purge. Following extraction, the nanoweb is then heated to a temperature of 300 to 350° C. for about 10 minutes or less, or 5 minutes or less, to fully imidize the nanoweb. Imidization according to the process hereof preferably results in at least 90%), or 100%, imidization.

The polyamic acid or polyimide nanoweb may optionally be calendered. “Calendering” is the process of passing a web through a nip between two rolls. The rolls may be in contact with each other, or there may be a fixed or variable gap between the roll surfaces. Advantageously, in the present calendering process, the nip is formed between a soft roll and a hard roll. The “soft roll” is a roll that deforms under the pressure applied to keep two rolls in a calender together. The “hard roll” is a roll with a surface in which no deformation that has a significant effect on the process or product occurs under the pressure of the process. An “unpatterned” roll is one which has a smooth surface within the capability of the process used to manufacture them. There are no points or patterns to deliberately produce a pattern on the web as it passed through the nip, unlike a point bonding roll. The calendaring process may also use two hard rolls.

The nanoweb can have mean flow pore size from 0.1 to 5.0 microns, or less than 3 μm, or less than 1.5 μm. The pore size distribution can be normal (Gaussian), symmetric and asymmetric about the mean, or any other distribution. “Mean flow pore size” refers here to mean flow pore size as measured according to ASTM Designation E 1294-89, “Standard Test Method for Pore Size Characteristics of Membrane Filters Using Automated Liquid Porosimeter.” Capillary Flow Porometer CFP-2100AE (Porous Materials Inc. Ithaca, N.Y.) was used for measurements made herein. Individual samples of 25 mm diameter) are wetted with a low surface tension fluid (1,1,2,3,3,3-hexafluoropropene, or “Galwick,” having a surface tension of 16 dyne/cm) and placed in a holder, and a differential pressure of air is applied and the fluid removed from the sample. The differential pressure at which wet flow is equal to one-half the dry flow (flow without wetting solvent) is used to calculate the mean flow pore size using supplied software.

The thickness of the nanoweb can be less than 100 microns, or less than 50 microns, or less than 25 microns, or less than 15 microns. The porosity of the nanoweb, defined as percentage of the volume of the nanoweb not occupied by fibers, can range between 10% and 90%, or between 30% and 75%, or between 40% and 65%. The air permeability of the nanoweb can range between 0.05 and 1000 (s/100 cm³) Gurley, or between 0.05 and 500 (s/100 cm³), or between 0.07 and 100 (s/100 cm³), or between 0.1 and 50 (s/100 cm³), and or between 1 and 10 (s/100 cm³). The ionic resistivity of the nanoweb at ambient conditions can range from 100 (ohm*cm) to 2000 (ohm*cm), more preferably between 200-1000 (ohm*cm), and even more preferably between 600 and 900 (ohm*cm).

In one embodiment, the second layer of the laminate is a coating that comprises a first set of particles on one or both outside surfaces of the web, the particles forming a porous layer on said surfaces. An individual coating may contain continuous or discontinuous regions of particles either separately or in contact with each other. The term “particle” refers to the smallest identifiable subdivision of the material or materials from which the coating is made. Each particle is defined by a continuous surface and the surfaces of different particles may touch, or be bonded to neighboring particles or to the nanoweb.

The coating may be applied by the application of a flocculated colloidal material to the nanoweb to form the second layer. Any suitable coating technique may be used to form the second layer.

A particle has its smallest identifiable subdivision characterized by a number average maximal external diameter that is smaller than the mean flow pore size of the nanoweb. “Maximal external diameter” is synonymous to “size” herein and refers to the largest dimension of the discrete entity.

In one embodiment, the second layer may be characterized in that the particles that the layer comprises are of colloidal dimensions or “flocs” and are flocculated before being applied to the web. “Flocculated” means that the smaller particles maintain their individual identity but are held together as a porous material with each particle having a set of nearest neighbor particles in contact with it. The porosity of the porous material may be 15% or more, 40% or more, or even 50% or more or even 60% or more. The porosity of the porous material may preferably also be less than 70%.

Particles may be flocculated from a colloidal suspension by, for example, addition of organic solvents to the suspension or increasing the ionic strength (e.g. by adding salts) of the suspension in which the colloid is suspended or by varying the pH of the suspension.

The total thickness of the laminate can be less than 100 microns, or less than 50 microns, or less than 25 microns, or less than 15 microns. In a further embodiment, the separator comprises a first set of thermoplastic particles, wherein the nonwoven web can be characterized as having a mean flow pore size, and the number average particle size of the first set of thermoplastic particles is less than or equal to the mean flow pore size. Preferably, the majority of the thermoplastic particles have a size less than the mean flow pore size of the nanoweb. In a further embodiment of the invention, greater than 60% or even greater than 80% or 90% or even 100% of the particles have a size less than the mean flow pore size of the nanoweb.

The number average particle size may also be less than or equal to 80% of the mean flow pore size. The number average particle size may also be less than or equal to 70% of the mean flow pore size. The number average particle size may also be less than or equal to 60% of the mean flow pore size. The number average particle size may also be less than or equal to 50% of the mean flow pore size.

Particles may be aggregated on the surface of the web, even to the extent that the discrete nature of the particles is not evident in micrographs of the porous layer in comparison to the pore size within the nanoweb.

The particles used in the first set of particles are thermoplastic and preferably thermoplastic polymers. “Thermoplastic” may be defined as exhibiting a “melting point”, defined in a phase diagram as the temperature at which the liquidus and solidus coincide at an invariant point at a given pressure per ASTM E1142 incorporated as a reference in ASTM D3418.

The melting point of the particles may be characterized by differential scanning calorimetry, for example, using standard tests ASTM D3418 or ISO 11357, both hereby incorporated by reference in their entirety. A thermoplastic polymer may have a range of melting characterized by an onset melting temperature and a peak melting temperature, also measured according to ASTM D3418. “Melting point onset” is synonymous to “melting extrapolated onset temperature” defined in ASTM D3418 as the value of the independent parameter (temperature) found by extrapolating the dependent parameter (enthalpy) from the heating differential scanning calorimetry (DSC) curve baseline prior to the event of melting and a tangent constructed at the inflection point on the leading edge to their intersection.

Thermoplastic may also include any material that exhibits flow behavior at a temperature where particles lose their structural integrity. In some embodiments, the thermoplastic is a polymer (such as those described in further detail below), oligomer, wax or blends thereof. The polymer may be a homopolymer or copolymer or any combination of any number of monomers that yield a thermoplastic polymer. Examples of suitable polymers are polyolefins, such as a polyethylene, polypropylene or polybutene or mixtures thereof.

The polymer chains can be functionalized to modify their properties. Functionalization includes oxidation to, for example, modify the surface energy of the particles to improve their dispersability, grafting of oligomer to, for example, modify the melt rheology of the polymer, or any other functionalization known in the art. The particles can in turn be functionalized prior to being dispersed to modify their properties, such as by coating, oxidation, grafting, chemical vapor deposition, surface plasma treatment, ozone treatment, and other functionalization methods known in the art. The particles can also be bicomponent polymeric particles having side-by-side or core-shell structures or be composite particles composed of a polymeric phase reinforced with inorganic particles.

The particles can be non-polar or polar. The polarity of a substance can be determined, for example, by the acid number. The acid number (or “neutralization number” or “acid value” or “acidity”) is a measure of the amount of carboxylic acid groups in a chemical compound, or in a mixture of compounds. It is defined as the mass of potassium hydroxide (KOH) in milligrams (mg) that is required to neutralize one gram (g) of chemical substance. In a typical procedure, a known amount of sample dissolved in organic solvent is titrated with a solution of potassium hydroxide with known concentration and with phenolphthalein as a color indicator. The acid number can be determined following standard method ASTM D974. The particles in the laminate can have an acid number of 200 mgKOH/g, or less than 100 mgKOH/g, or less than 50 mgKOH/g, or less than 10 mgKOH/g.

In another embodiment, there may be a first set of thermoplastic particles as described above and in addition a second set of polymeric or non-polymeric particles, applied separately or blended together, in which the first and second sets are made of different materials, or of the same material but with other differences as described hereafter. The second set of particles may form a third layer, or be aggregated with the first set of particles into the second layer of the laminate.

The first and second set of particles may have different shapes and sizes, or have different functionalities. The first and second sets, for example, may also have different thermal properties, such as different melting points, and different melt viscosities. The non-polymeric particles used in the second set of particles may be, for example, ceramic particles. Polymeric particles useful in the second set are preferably selected from the same group of thermoplastic particles described above for the first set of particles. More than two sets of particles can also optionally be used and applied separately or blended together with one or more other sets of particles. The particles can be produced by micronization, by grinding, by milling, by prilling, by electrospraying, or by any other process known in the art. The particles can be colloidal particles.

In one embodiment, the second set of particles do not melt or flow at temperatures up to 200° C. In other embodiments, the second set of particles have a mean particle size of at least equal to the mean flow pore size and have a melting point onset of between 80° C. and 130° C.

Any particles as used herein may be spherical but need not be spherical. The particles can have a high aspect ratio, a low aspect ratio, or the particles can be a mixture of both types of particles or even irregularly shaped particles. The term “aspect ratio” of a particle is defined herein as a ratio of a largest dimension of the particle divided by a smallest dimension of the particle. The aspect ratios can be determined by scanning under an electron microscope and visually viewing the outside surfaces of the particles to determine the lengths and thicknesses of the particles. The use of single digits and the use of two digits to describe aspect ratio herein are synonymous. For example the terms “5:1” and “5” both have the same meaning. A low aspect ratio particle is defined as being a particle having an aspect ratio of from 1:1 to about 3:1 and such particles can also be used in the structure of the invention.

All of the particles may further have an aspect ratio of 1, or between 1 and 120, or even between 3 and 40. The number average aspect ratio of the particles may further have an aspect ratio of between 1 and 120, or even between 3 and 40. In a further embodiment at least 10% and preferably at least 30% and even at least 50% or 70% of the particles have an aspect ratio of between 1 and 120, or even between 3 and 40. Blends of particles may also be used in which one plurality of particles have a high aspect ratio and another plurality of particles have a low aspect ratio.

All or any of either the first or second set particles as defined above may further have an aspect ratio of between 3 and 120, or 5 and 120, or 10 and 120, or even between 3 and 40, or 5 and 40, or 10 and 40. The number average aspect ratio of the first or second set or both sets of particles may further have an aspect ratio of between 3 and 120, or 5 and 120, or 10 and 120, or even between 3 and 40, or 5 and 40, or 10 and 40. In a further embodiment at least 10% or at least 30% and even at least 50% or 70% of the particles have an aspect ratio of between 3 and 120, or 5 and 120, or 10 and 120, or even between 3 and 40, or 5 and 40, or 10 and 40.

There is therefore no particular limitation to the upper or lower limit of the number average aspect ratio of either set of particles. The particles can also be irregularly shaped, for example as would be the case if the particles were prepared by micronization or grinding.

The thermoplastic particles are preferably made from a material which melts below the melting or softening temperature of the nanoweb. The thermoplastic particles are preferably characterized by having a melting or softening temperature onset of between 70° C. and 160° C. The thermoplastic particles may have a melting or softening onset of between 90° C. and 150° C. or even between 110° C. and 140° C. These are useful ranges as concerns the ability of the cell to shut down while at a safe temperature.

In a further embodiment, the separator comprises a second set of particles coated onto a surface of the nonwoven web. The second set of particles may be coated either to the same surface as the first set of particles, or to the opposing surface. The number average particle size of the second set of particles may be at least equal to the mean flow pore size of the nonwoven web or may be less than the mean flow pore size of the web. In some embodiments, the second set of particles are less than the mean flow pore size of the nanoweb web and are coated to the same surface as the first set of particles and/or coated to the opposing surface of the nanoweb. In other embodiments, the second set of particles are equal to or greater than the mean flow pore size of the nanoweb web and are coated to the same surface as the first set of particles and/or coated to the opposing surface of the nanoweb. In other embodiments, the second set of particles has a mean particle size of at least 2 times, at least 5 times, at least 10 times and in some cases even at least 20 times the mean flow pore size of the nanoweb and are coated to the same surface as the first set of particles and/or coated to the opposing surface of the nanoweb. The maximum number average particle size of the second set of particles is such that the target thickness of the coated nanoweb is not exceeded.

In a further embodiment, the separator comprises a second set of particles coated to the surface formed by the first set of particles. Additional sets of particles can be subsequently coated to the coated nonwoven web forming a multilayered coating.

The particles used herein may also comprise a blend of a first set of particles with the onset of melting point specified above, and a second set of particles with a different onset of melting point from the first set of particles, or even the same onset of melting point. In certain embodiments, the weight percentage of the first set of particles by weight of total particles coated on the nanoweb can be at least 1%, or 40%, or 60% or even at least 80% or 99%.

The particles used herein may also be a blend of polymeric and non-polymeric particles, such as for example, a first set of thermoplastic particles with a second set of non-polymeric particles, such as ceramic particles.

Where particle aggregates in any particular layer have been formed by flocculation, the flocculated particles may be applied to the web by a variety of methods. For example, particle suspensions may be applied by standard coating processes such as gravure coating, slot die coating, draw-down coating, roller coating, dip coating, curtain coating methods or any printing methods. The coating process may include a drying step to remove the continuous phase. Particles may be applied in multiple layers, with one type per layer, or a different blend of particle types in each layer.

The coating may be stabilized onto the nonwoven web. Stabilization indicates that sufficient permanent interaction is created between particles in a layer and between particles and the nonwoven web, so that the laminate can withstand the remaining process steps and fabrication of the electrochemical cells. The stabilization is typically done during the drying step of the coating process. During drying, sufficient heat may be applied to the laminate to remove the continuous phase, and to soften or partially melt the outer surface of the particles, resulting in the particles partially fusing together in a layer to form a porous network and fusing to the nonwoven web.

Alternatively, one set of particles in a layer can act as a binder phase for another set of particles in the same layer. The binder phase can be composed of polymer particles that have a lower melting temperature compare to the particles that provide shutdown functionality. During drying, the binder particles melt and flow, and, upon cooling, solidify and create a link between the intact particles and between those particles and the nonwoven web. Alternatively, the binder phase can be an oligomer or a polymer, such as a polyethylene oxide, dissolved in the continuous phase. Alternatively, the particles can be stabilized onto the nonwoven web by spraying an adhesive onto the coating. Alternatively, the particles can be stabilized by applying an adhesive film onto the nonwoven web and then coating with the particle dispersion or by applying an adhesive film onto the coating. In this case, the adhesive film will melt and fuse the particles together and fuse the particles to the nonwoven web during the stabilization step.

Alternatively, the stabilization can be done by thermal calendaring, in line with the coating process or as a separate processing step.

In another embodiment of the present invention, the particles used to form the second layer and/or subsequent layers of the laminate are applied to the nanoweb or laminate as a coating which contains less than about 20 wt %, or 10 wt %, or 5 wt %, or 1 wt %, or 0.5 wt %, or 0.1 wt %, or 0.05 wt %, or 0.01 wt % surfactants. In some embodiments the amount of surfactant in the applied coating is less than 1 wt %.

The laminate hereof offers a shutdown functionality. The shutdown functionality indicates that the coated separator provides a means to significantly increase the ionic resistance (i.e. reduce the ionic conductivity) of the separator at a specific temperature threshold. Below the threshold temperature, the laminate allows for the flow of ions from one electrode to the other.

The thermoplastic materials used in the second layer of the laminate and optional subsequent layers can be characterized by their zero shear viscosity. Zero shear viscosity refers to the viscosity at the limit of low shear rate. Zero shear viscosity can be measured by a variety of methods including, for example capillary rheometry, ASTM D3835 (ISO 11443), both hereby incorporated by reference in their entirety. The thermoplastic particles useful in the invention (including the first and second set of particles) may have a zero shear viscosity at 140° C. less than 1,000,000 centipoise (cP) or less than 100,000 cP, or less than 10,000 cP. In other embodiments, the thermoplastic particles useful in the invention may have a zero shear viscosity at 140° C. above 50 cP, or above 100 cP, or above 500 cP or between 50 cP and 100,000 cP. In yet other embodiments, the thermoplastic particles useful in the invention may have a zero shear viscosity at 190° C. between 50 and 15,000,000 (cP) or between 50 cP to 100,000 cP. This property has an effect on the time it takes for the particles after they reach their melting point to flow and close the pores of the nanoweb.

The separator offers a shutdown functionality and also is preferably, structurally and dimensionally stable, as defined by a shrinkage of less than 10%, 5%, 2% or even 1%, at temperatures up to 200° C. to prevent electrical short circuiting due to the degradation or shrinkage of the separator.

In another aspect, the invention provides an electrochemical cell, especially a lithium or lithium-ion battery, comprising a housing having disposed therewithin, an electrolyte, and a multi-layer article at least partially immersed in the electrolyte; the multi-layer article comprising a first metallic current collector, a first electrode material in electrically conductive contact with the first metallic current collector, a second electrode material in ionically conductive contact with the first electrode material, a porous separator disposed between and contacting the first electrode material and the second electrode material; and, a second metallic current collector in electrically conductive contact with the second electrode material, wherein the porous separator comprises a nanoweb that includes a plurality of nanofibers. In some embodiments, the nanofibers comprise a fully aromatic polyimide. In other embodiments, the nanofibers preferably consist essentially of, or in the alternative consist only of, a fully aromatic polyimide. Ionically conductive components and materials transport ions, and electrically conductive components and materials transport electrons.

In one embodiment of the electrochemical cell hereof, the first and second electrode materials are different, and the electrochemical cell hereof is a battery, preferably a lithium ion battery. In an alternative embodiment of the electrochemical cell hereof, the first and second electrode materials are the same and the electrochemical cell hereof is a capacitor, preferably an electronic double layer capacitor. When it is stated herein that the electrode materials are the same it is meant that they comprise the same chemical composition. However, they may differ in some structural component such as particle size.

In a further embodiment of the multi-layer article of the invention, at least one electrode material is coated onto a non-porous metallic sheet that serves as a current collector. In a preferred embodiment, both electrode materials are so coated. In the battery embodiments of the electrochemical cell hereof, the metallic current collectors can contain different metals. In the capacitor embodiments of the electrochemical cell hereof, the metallic current collectors can contain the same metal. The metallic current collectors suitable for use herein are preferably metal foils.

The following examples illustrate the invention without, however, being limited thereto.

### EXAMPLES

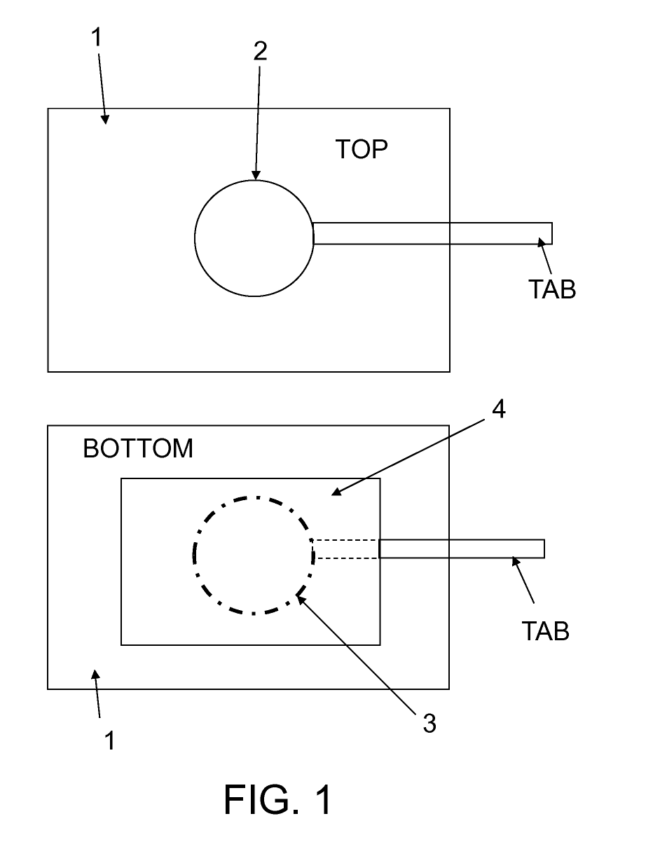

An electro-blown spinning or electroblowing process and apparatus for forming a nanofiber web of the invention as disclosed in WO 2003/080905, as illustrated in FIG. 1 thereof, was used to produce the nanofiber layers and webs of the examples below. Polyamic acid webs were prepared from a solution of PMDA/ODA in dimethyl formamide (DMF) and electroblown as described herein. The nanofiber layers and webs were then heat treated according to the procedure described in copending U.S. patent application Ser. No. 12/899,770, previously incorporated by reference herein in its entirety for reference. Finally, the webs were calendered through a steel/cotton nip at 140 pounds per linear inch and 160° C.

Table 1 summarizes the properties of the resulting nanowebs (without the particle coating) used to prepare the examples below. All nanowebs were composed of fully imidized polyimide fibers having an average fiber size between 600-800 nm. The mean and maximum pore sizes (as reported in Table 1) were determined by means of a capillary flow porometer, model CFP-2100-AE (Porous Materials Inc., 20 Dutch Mill Rd. Ithaca, N.Y.). Measurements were made according toe the “dry-up/wet-up” method as described by the manufacturer with circular specimens 1″ in diameter and Galwick fluorocarbon as the liquid phase.

TABLE 1
Average properties of the nanoweb without particle coating.

| | | | | Mean | Air |
|---|---|---|---|---|---|
| | Basis | Thickness, | | Flow Pore | permeability, |
| | weight, | μm (at | | size (mfp), | Gurley |
| Example | g/m² | 50 KPa) | Porosity, % | μm | s/100 cc |
| 1 | 15.3 | 24.5 | 56.3 | 0.5 | 5 ± 1 |
| 2 | 15.5 | 21 | 48.4 | 0.9 | 4 ± 1 |
| 3 | 15.5 | 21 | 48.4 | 0.9 | 4 ± 1 |
| Comp | 15.5 | 21 | 48.4 | 0.9 | 4 ± 1 |
| example | | | | | |

### Test Methods

Mean flow pore size was measured according to ASTM Designation E 1294-89, “Standard Test Method for Pore Size Characteristics of Membrane Filters Using Automated Liquid Porosimeter” incorporated herein by reference in its entirety. A capillary Flow Porometer CFP-2100AE (Porous Materials Inc. Ithaca, N.Y.) was used. Individual samples of 25 mm diameter were wetted with a low surface tension fluid (1,1,2,3,3,3-hexafluoropropene, or “Galwick,” having a surface tension of 16 dyne/cm) and placed in a holder, and a differential pressure of air was applied and the fluid removed from the sample. The differential pressure at which wet flow is equal to one-half the dry flow (flow without wetting solvent) was used to calculate the mean flow pore size using supplied software.

Basis Weight was determined according to ASTM D-3776 and reported in g/m2.

Porosity was calculated by dividing the basis weight of the sample in g/m2 by the polymer density in g/cm3 and by the sample thickness in micrometers and multiplying by 100 and subsequently subtracting from 100%, i.e., percent porosity=100−basis weight/(density×thickness)×100.

The air permeability was measured according to ASTM Designation D726-94, “Standard Test Method for Resistance of Nonporous Paper to Passage of Air” incorporated herein by reference in its entirety. Individual samples were placed in the holder of Automatic Densometer model 4340 (Gurley Precision Instruments, Troy, N.Y.) and an air at a pressure of 0.304 (kPa) is forced through an area of 0.1 inch² or 0.645 cm² of the sample, recalculated by software to 1 inch² or 6.45 cm². The time in seconds required for 100 (cm³) of air to pass through the sample was recorded as the Gurley air permeability with the units of (s/100 cm³ or s/100 cc).

Ionic Resistance is a measure of a separator's resistance to the flow of ions, and is measured using an AC impedance technique. Samples were cut into small pieces (31.75 cm diameter) and soaked in 1 M LiPF₆ in 30:70 Ethylene Carbonate/Ethyl Methyl Carbonate (EC/EMC) electrolyte. The separator resistance was measured using Solartron 1287 Electrochemical Interface along with Solartron 1252 Frequency Response Analyzer and Scribner Associates Zplot (version 3.1c) software. The test cell had a 5.067 square cm electrode area that contacted the wetted separator. Measurements were done at AC amplitude of 5 mV and the frequency range of 10 Hz to 100,000 Hz. The high frequency intercept in the Nyquist plot is the separator resistance (in ohm). The separator resistance (ohm) was multiplied with the electrode area (5.067 square cm) to determine ionic resistance in ohm-cm².

The shutdown test measures the increase in resistance as a function of temperature to determine the shutdown capability of battery separators. FIG. 1 illustrates a measurement cell useful for characterizing the shutdown properties of battery separators versus temperature. FIG. 1 illustrates separately the bottom part of the cell and the top part. The cell consists of two Stainless Steel (Type 304) disks which serve as electrodes. The bottom disk (3) is 25 mm, and the top disk (2) is 22 mm diameter, both of which are ⅛″ thick and embedded in Silicon rubber and Kapton polyimide film sandwich (1). Both stainless steel disks are fitted with stainless steel tabs as shown in FIG. 1. The separator (4) is saturated with organic electrolyte consisting of 1 M lithium Bis(trifluoromethanane)sulfonimide (Aldrich) in propylene carbonate (Aldrich).

The disks (2,3) and rubber were used to sandwich the electrolyte-saturated separator (4) by placing the separator between the disks and pressing them in a Carver press with heated platens. The platens were heated at a constant rate from room temperature to 200° C. using a Eurotherm model 2408 controller. The temperature of the electrode surface was measured by one E type thermocouple embedded in the bottom part of the cell with the thermocouple positioned adjacent to the bottom disk holding the separator. The tabs of the electrodes were connected with an Agilent 4338B milliohmmeter and the ionic resistance measurements were taken at 1 KHz as the temperature of the cell was ramped up. The test was stopped at ˜200° C. and the cell was cleaned after the temperature was allowed to drop to room temperature.

Shrinkage is a measure of the dimensional stability. The length of a sample in the machine-direction (MD) and cross-direction (CD) was measured. The sample was placed unrestrained on top of a horizontal support in a conventional laboratory convection oven for 10 minutes at an elevated temperature. The samples was then removed from the oven and allowed to cool down. The MD and CD lengths were then measured again. Shrinkage was calculated by dividing the surface area (MD length multiplied by the CD length) after heat exposure to the surface area before exposure to heat, subtracting this ratio to one, and multiplying by 100.

MacMullin Number (Nm) is a dimensionless number and is a measure of the ionic resistance of the separator. It is defined as the ratio of the resistivity of a separator sample filled with electrolyte to the resistivity of an equivalent volume of the electrolyte alone. It is expressed by:

Nm=(Rₛₑₚₐᵣₐₜₒᵣ×A_{electrode})/(P_{electrolyte}×tₛₑₚₐᵣₐₜₒᵣ), where
Rₛₑₚₐᵣₐₜₒᵣ is the resistance of the separator in ohms,
A_{electrode} is the area of electrode in cm²,
Pelectrolyte is the resistivity of electrolyte in ohm*cm, and
tₛₑₚₐᵣₐₜₒᵣ is the thickness of separator in cm.

### Example 1

### Characterization of Flocculated Particle Mass

Aqueous dispersions of colloidal, partially oxidized high density poly(ethylene) (CPE), 35% solids, acid number 35 mg/gm, comprising particles smaller than 200 nm stabilized with non-ionic surfactant was obtained from Chem Cor (48 Leone Lane, Chester, N.Y. 10918).

Four coating formulations were prepared comprising colloidal polyethylene (CPE) dispersions at 14 weight percent solids in aqueous solutions containing isopropyl alcohol in concentrations ranging from 51.2 to 59.5% IPA by volume. The extent of flocculation was found to increase with increasing IPA content as evidenced by their relative resistance to flow. Samples of Polyimide nano-fiber webs were immersed in these formulations and withdrawn between coating rods with various gaps to create uniform layers on contact with the nanowebs. The samples were then dried at approximately 80° C. to create porous layers of CPE particles as summarized in Table 2. Scanning electron microscopy of cross-sections confirmed that the majority of the CPE particles were deposited as a uniform layer on the external surfaces of the nanoweb. At much higher magnification electron microscopy showed that this layer consists of a porous network of discrete particles approximately 50 nm in diameter. For each sample the weight and thickness of the coating were determined by subtracting the weight and thickness of an equivalent area of uncoated nanoweb, and the density of the coating was calculated as follows:

(coating density)=coating weight/(coating thickness×area)

The porosity was then estimated from the formula:

Coating Porosity (%)=(1−(coating density)/(polyethylene density))*100%

This estimate represents a lower bound to the true coating porosity since it fails to adjust for the small fraction of HDPE particles that may have deposited within the polyimide substrate.

The data in Table 2 show that the coating porosity increases systematically with the IPA concentration of the coating formulation. This is consistent with the expectation that more highly flocculated dispersions are more resistant to densification during drying. Coatings with porosity greater than 70% were particularly fragile and tended to crack during drying. This example demonstrates the utility of flocculated colloidal dispersions as a means to selectively coat the surfaces of a porous substrate and also to systematically control the porosity of the coating.

TABLE 2
Nanoweb samples coated from colloidal polyethylene (CPE) dispersions
at 14 weight percent solids flocculated with various concentrations
of isopropyl alcohol (IPA).

| IPA Concentration | Coating Thickness | |
|---|---|---|
| volume-% | μm | Porosity (%) |
| 51.2 | 27 | 15 |
| ″ | 45 | 31 |
| 55.7 | 47 | 71 |
| ″ | 43 | 65 |
| ″ | 55 | 64 |
| ″ | 43 | 61 |
| ″ | 53 | 66 |
| ″ | 40 | 63 |
| 58.2 | 69 | 68 |
| ″ | 58 | 73 |
| ″ | 52 | 72 |
| ″ | 45 | 70 |
| 59.5 | 66 | 79 |

### Comparative Example

A sample of polyimide nanoweb was prepared according to the electroblowing process described above and in PCT publication number WO 2003/080905, as illustrated in FIG. 1 thereof. The basis weight of the web was 15.5 grams per square meter (gsm), thickness was 21 microns under a load of 50 kPa. Porosity of the sample was 48.4% with a mean flow pore size of 0.9 microns. The resistivity of the sample was 643 ohm-cm or 5.4 McMullin number.

Shrinkage of the separator was determined to be less than 1% at temperatures of 120° C., 130° C., 147° C., 175° C. and 200° C. by measuring the surface area of the sample before and after subjecting it to the respective specified temperatures for 10 minutes.

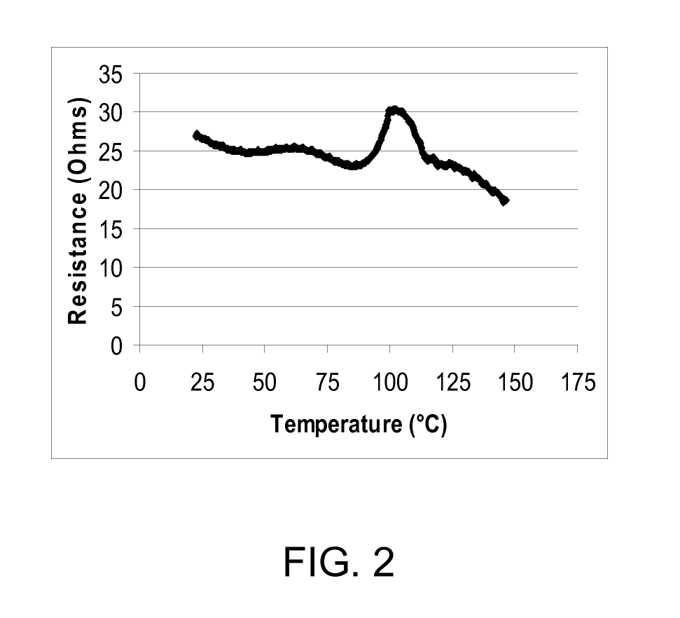

FIG. 2 shows the effect of temperature on electrical resistance for this nanoweb. There is no appreciable increase in electrical resistance as a function of temperature.

### Example 2

An aqueous dispersion of colloidal, partially oxidized high density poly(ethylene) (CPE), 35% solids, acid number 35 mg/gm, comprising particles smaller than 200 nm stabilized with non-ionic surfactant was obtained from Chem Cor (48 Leone Lane, Chester, N.Y. 10918). Melting temperature was 127° C. and melt onset temperature was 120° C.

In the preferred procedure for coating, the as-received dispersion was flocculated to create a thixotropic fluid by combining 3 parts by volume of dispersion with 3 parts iso-propanol and 1 part de-ionized water. The viscosity and yield stress of this fluid facilitated coating by preventing sagging or redistribution during the coating operation and, because the flocculated aggregates can be larger than the pores in the web, the CPE particles tend to accumulate more on the external surfaces of the web where they can more effectively sinter into a fully dense mass. A sample of polyimide nano-fiber web (porosity 48%, 21 microns thick) was immersed in the flocculated dispersion and drawn through a 0.005″ gap between Pyrex cylinders (¾″ in diameter), then dried at 85° C., rinsed with methanol to remove the surfactant and redried at 85° C. The content of poly(ethylene) was determined to be 39% by weight. Scanning electron micrography showed that CPE particles formed dense-packed (partially cracked) layers on both surfaces but did not completely fill the pores in the center of the web.

Shrinkage of the separator was determined to be less than 1% at temperatures of 120° C., 130° C., 147° C., 175° C. and 200° C. by measuring the surface area of the sample before and after subjecting it to the respective specified temperatures for 10 minutes.

### Example 3

An aqueous dispersion of colloidal, partially oxidized high density poly(ethylene) (CPE), 35% solids, acid number 35 mg/gm, comprising particles smaller than 200 nm stabilized with non-ionic surfactant was obtained from Chem Cor (48 Leone Lane, Chester, N.Y. 10918). Melting temperature was 127° C. and melt onset temperature was 120° C.

In the preferred procedure for coating, the as-received dispersion was flocculated to create a thixotropic fluid by combining 3 parts by volume of dispersion with 3 parts iso-propanol and 1 part de-ionized water. The viscosity and yield stress of this fluid facilitated coating by preventing sagging or redistribution during the coating operation and, because the flocculated aggregates can be larger than the pores in the web, the CPE particles tend to accumulate more on the external surfaces of the web where they can more effectively sinter into a fully dense mass. A sample of polyimide nano-fiber web (porosity 48%, 21 microns thick) was immersed in the flocculated dispersion and drawn through a 0.005″ gap between Pyrex cylinders (¾″ in diameter), then dried at 85° C., rinsed with methanol to remove the surfactant and redried at 85° C.

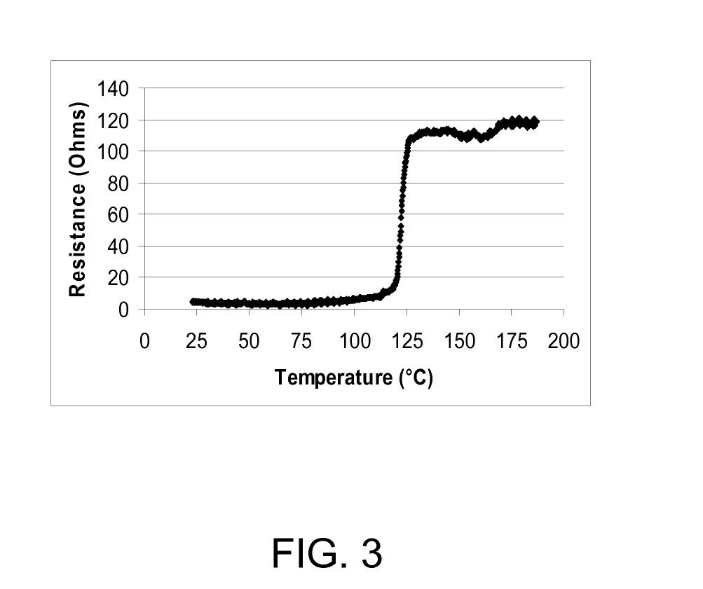

FIG. 3 shows the effect of temperature on ionic resistance for a nano-fiber webs having the CPE content of the coated web of 35% of the total web plus coating. A significant increase in ionic resistance was observed around 120° C., signifying the shutdown behavior in this sample. The sample also maintained its resistance on continued heating till 200° C., signifying the excellent high temperature melt integrity of the substrate.

Shrinkage of the separator was determined to be less than 1% at temperatures of 120° C., 130° C., 147° C., 175° C. and 200° C. by measuring the surface area of the sample before and after subjecting it to the respective specified temperatures for 10 minutes.

Table 3, below, shows a comparison of the resistances of the nanowebs in example 3 and the comparative example at two temperatures (room temperature and 70° C.) plus the resistance at maximum shutdown temperature.

TABLE 3

| | Specific Resistance, | | | | |
|---|---|---|---|---|---|
| | ohm · cm², | | | | |
| | at different temperatures | | | Resistance ratio | |
| | | | Max shutdown | R@max/ | R@max/ |
| | | | (at temperature, | R@ | R@ |
| Example | 25° C. | 70° C. | ° C.) | 25° C. | 70° C. |
| Comparative | 91 | 91 | 87 (150° C.) | 1.0 | 1.0 |
| Example | | | | | |
| Example 3 | 15 | 13 | 426 (136° C.) | 28 | 32 |

Comparison of FIGS. 2 and 3 and Table 3 shows the positive effect of the invention on the shutdown capability of the nanoweb. The nanoweb in Example 3 showed an appreciable increase in resistance during shutdown, while the nanoweb in comparative example showed no increase in resistance at higher temperatures.

What is claimed is:

1. A laminate comprising a first layer comprising nanofibers arranged into a nonwoven web, and second layer comprising a first set of thermoplastic particles, said second layer being bonded to the first layer and covering at least a portion of the surface of the first layer, and wherein the nonwoven web has a mean flow pore size of between 0.1 microns and 5 microns, and the particles have a number average particle size less than the mean flow pore size.

2. The laminate of claim 1 wherein the particles are bonded into a coherent layer wherein the coherent layer has a porosity of less than 70%.

3. The laminate of claim 1 in which the thermoplastic particles are polymer particles.

4. The laminate of claim 1 in which the number average particle size is less than or equal to 80% of the mean flow pore size.

5. The laminate of claim 1 in which the thermoplastic particles have a melting point onset of between 80° C. and 180° C.

6. The laminate of claim 1 which further comprises a third layer bonded with either the first layer or the second layer or both, wherein the third layer comprises a second set of particles.

7. The laminate of claim 6 in which the particles of the second set of particles do not melt or flow at temperatures up to 200° C.

8. The laminate of claim 6 in which the particles of the second set of particles have a mean particle size of at least equal to the mean flow pore size and have a melting point onset of between 80° C. and 130° C.

9. The laminate of claim 8 in which the particles of the second set of particles has a mean particle size of at least 5 times the mean flow pore size.

10. The laminate of claim 6 in which the particles of the first or second set of particles or both are stabilized onto the nonwoven web by a method selected from the group consisting of heat treatment or thermal calendering.

11. The laminate of claim 6 in which the particles of the first and second sets of particles are blended before being applied to the nonwoven web.

12. The laminate of claim 6 in which the particles of the first or the second set of particles or both are functionalized.

13. The laminate of claim 6 in which the particles of the first or second sets of particles or both comprise core-shell, bi-component or composite particles.

14. The laminate of claim 1 where the particles are stabilized by binder particles, a dissolved oligomer or polymer, or an adhesive spray or film.

15. The laminate of claim 1 comprising a plurality of distinct nonwoven webs where the nonwoven webs are separated from each other by particles.

16. The laminate of claim 1 in which the ionic resistance increases by at least 2 times the initial resistance upon reaching a preselected threshold temperature, and which is structurally stable at temperatures up to 200° C. such that the shrinkage is less than 10%.

17. The laminate of claim 16 which is structurally stable at temperatures up to 200° C. such that the shrinkage is less than 1%.

18. The laminate of claim 1 comprising particles having an acid number of less than 200 mgKOH/g.

19. The laminate of claim 1 in which the particles used to form the second layer are applied as a coating that contains less than about 5 wt surfactants.

20. The laminate of claim 1 wherein the first set of thermoplastic particles are flocculated.

21. An electrochemical cell comprising a laminate according to claim 1.

22. A lithium ion battery comprising a laminate according to claim 1.

23. A process for manufacturing a laminate comprising the step of coating a nanoweb with a floc of thermoplastic particles wherein the floc forms a layer on the nanoweb and comprises particles that have a number average particle size of less than or equal to the mean flow pore size of the nanoweb.

24. A laminate made by the process of claim 23.
